(19) United States
(12) Patent Application Publication
(10) Pub. No.: US 2008/0271695 A1
(43) Pub. Date: Nov. 6, 2008

(54) POWER SYSTEM FOR AND METHOD OF POWERING A VEHICLE

(76) Inventor: Carroll Morton, Fairacres, NM (US)

Correspondence Address: GRADY K. BERGEN, 3333 LEE PARKWAY, SUITE 600, DALLAS, TX, 75219, US

(21) Appl. No.: 12/112,730

(22) Filed: Apr. 30, 2008

Related U.S. Application Data
(60) Provisional application No. 60/915,873, filed on May 3, 2007.

(51) Int. Cl. F02N 7/10

(52) U.S. Cl. 123/179.19

(57) ABSTRACT

A power system is provided for a vehicle includes a primary combustion engine for powering a drive system of the vehicle for propelling the vehicle and non-drive systems associated with the vehicle in a first mode of operation. An auxiliary combustion engine is coupled to the primary engine for powering the non-drive systems in a second mode of operation when the primary combustion engine is powered off. The auxiliary engine is powered by the same fuel as the primary engine. The auxiliary combustion engine is coupled to the primary engine through at least one clutch that disengages and engages the auxiliary engine from the primary engine when the primary engine is powered on and off. A method of powering a vehicle is accomplished by powering a drive system of the vehicle for propelling the vehicle and non-drive systems associated with the vehicle through a primary combustion engine in a first mode of operation. When the primary combustion engine is powered off in a second mode of operation, the non-drive systems are powered by an auxiliary combustion engine that is coupled to the primary engine. The auxiliary engine is powered by the same fuel as the primary engine. The auxiliary combustion engine is coupled to the primary engine through at least one clutch that disengages and engages the auxiliary engine from the primary engine when the primary engine is powered on and off.

### CROSS REFERENCE TO RELATED APPLICATIONS

This application claims the benefit of U.S. Provisional Patent Application No. 60/915,873, filed May 3, 2007, which is herein incorporated by reference in its entirety.

### BACKGROUND

Semi-trucks and other large vehicles (e.g. bulldozers, cement mixers, combines, etc.) require large combustion engines that are used for powering drive systems for propelling the vehicle. Such vehicles may be very heavy themselves or may be used in transporting heavy loads. As a result, the engines for such vehicles must be designed to provide a high degree of power. The non-drive systems of the vehicle, such as the electrical system, pumps, cooling system, hydraulics, etc. are also powered by the combustion engines. When the truck or vehicle is parked or not moving and it is desired to maintain or continue to operate the non-drive systems without depleting the vehicles battery, the engine must continue to run. Often, in semi-trucks or other vehicles the engine may be left running for very long periods of time while the vehicle is parked or not moving to operate the non-drive systems of the vehicle. For example, semi-trucks are often provided with spacious cabs with sleeping accommodations to house the driver while the driver is not driving. The engine of the vehicle will typically be kept running to power electrical, cooling or heating systems so that the driver remains comfortable within the cab. When the engine is operated solely to run the non-drive systems of the vehicle, however, a large amount of fuel may be wasted because of the high fuel requirements for powering the large engine of the vehicle.

What is therefore needed are methods and systems for providing power to the non-drive systems of the vehicle that are more fuel efficient when the vehicle is not moving or when it is not necessary to propel the vehicle.

### BRIEF DESCRIPTION OF THE DRAWINGS

For a more complete understanding of the present invention, reference is now made to the following descriptions taken in conjunction with the accompanying figures, in which:

FIG. 1 is a schematic representation of a power system in accordance with the invention;

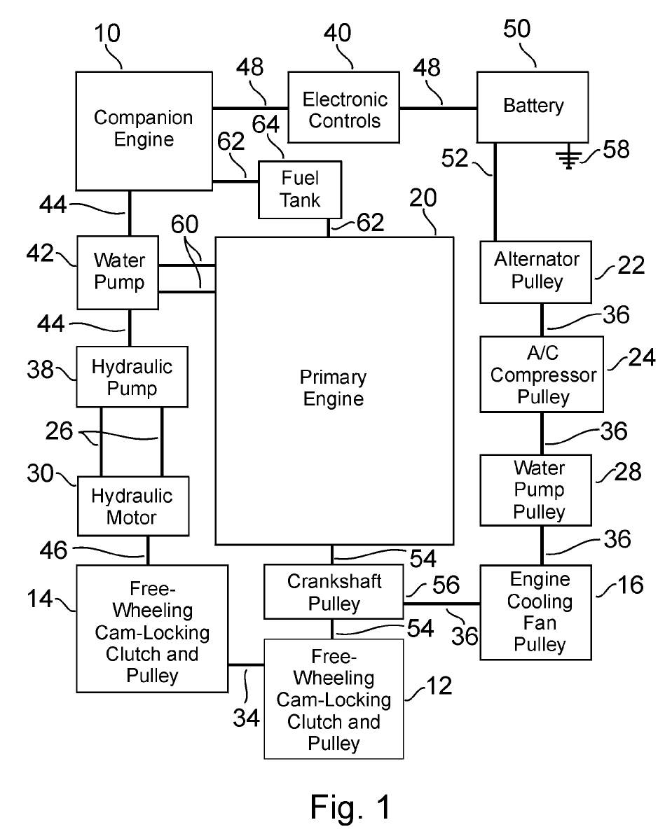

FIG. 2 is a perspective view of a pulley system of the power system of FIG. 1 incorporating a hydraulic motor; and

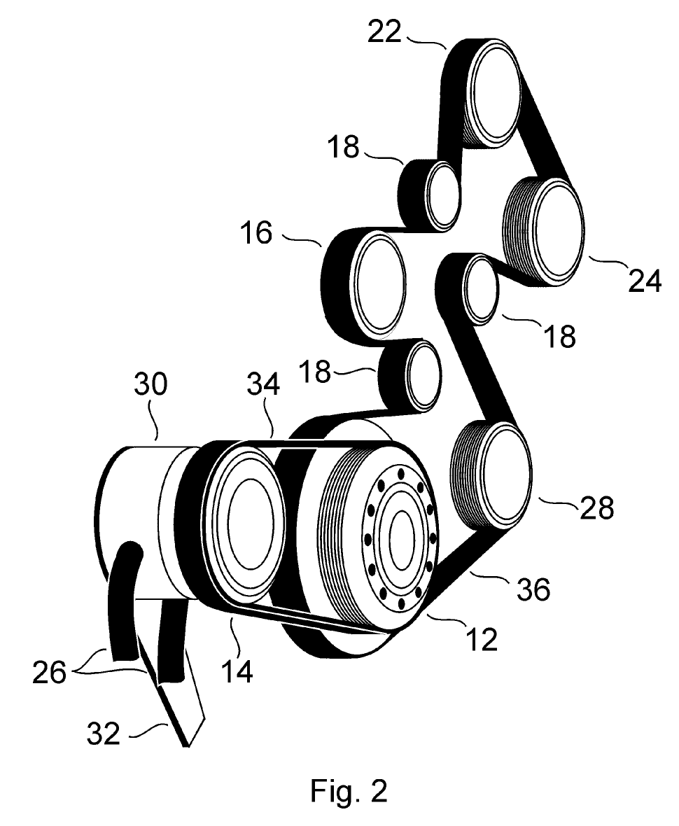

FIG. 3 is a perspective view of a pulley system of the power system of FIG. 1 without a hydraulic motor.

### DETAILED DESCRIPTION

This invention comprises a secondary or companion engine that is physically connected to the primary combustion engine of a vehicle for the purpose of operating ancillary equipment, as desired, when said primary engine has been shut down. The vehicle is mounted on wheels that are driven by the primary engine. In particular, the vehicle may be semi-tractor trailer, or other large vehicle. The implementation of this invention requires only the modification or replacement of a crankshaft pulley on said primary engine, as described below. One embodiment of this invention provides for automatic starting and stopping of said secondary engine, as described below, but can be designed to manually start or stop, if desired.

The secondary combustion engine is a prime mover that may operate on the same fuel as said primary engine, but consumes approximately 20%, 15%, 10% or 5% as much fuel as said primary engine and develops approximately 5% of the brake horsepower as said primary engine. The fuel may be a hydrocarbon fuel and may include such fuels as diesel, gasoline, biodiesel, liquid biofuels, ethanol, methanol, methane or light hydrocarbon gases. In certain applications, the primary and auxiliary engines may operate on different fuels. The secondary or auxiliary engine is electrically connected to the same storage batteries as said primary engine and uses fuel from the same fuel storage tank as said primary engine. This engine can be mounted at any point on a vehicle that does not interfere with the operation of said vehicle or cause safety concerns for said vehicle. The auxiliary engine may be mounted in the same engine compartment as the primary engine.

One purpose of the secondary engine is to provide centrifugal energy from a rotating crankshaft of said secondary engine to operate a hydraulic pump, physically connected by hydraulic hoses to a hydraulic motor that is bracketed to said primary engine and spinning a freewheeling cam-locking clutch attached to a pulley that is connected by a flexible belt to a freewheeling cam-locking clutch attached to the crankshaft pulley of said primary engine. Connected in this fashion, said freewheeling cam-locking clutch attached to said crankshaft pulley will continue to spin the primary engine cooling fan pulley and will continue to spin the water pump pulley of said primary engine and will continue to spin the alternator pulley of said primary engine to maintain electric power for said vehicle and it will continue to spin the refrigerant compressor pulley of said primary engine to provide cooling for the cabin of said vehicle. Another purpose of the secondary engine is to provide heated fluid from the cooling system of said secondary engine and circulate it by hoses through the cooling system of said primary engine to provide heat for said primary engine and to provide heat for the cabin of said vehicle. A manifold water jacket heat exchanger can also be added to said secondary engine if additional heat is required for the cooling system of said primary engine.

The freewheeling cam-locking clutch operates similar to a Morse one-way cam or roller ramp clutch, also referred to as “freewheels,” “sprag clutches” or “one-way clutches.” While said primary engine is in operation, said freewheeling cam-locking clutches attached to pulleys create almost no drag on said primary engine and, consequently, create no additional horsepower drain or fuel consumption. When said primary engine is shut down, an electrical switch is automatically tripped to start said secondary engine, which runs at a predetermined speed and performs aforementioned functions. A manual override switch can be tripped to stop or restart said secondary engine as desired.

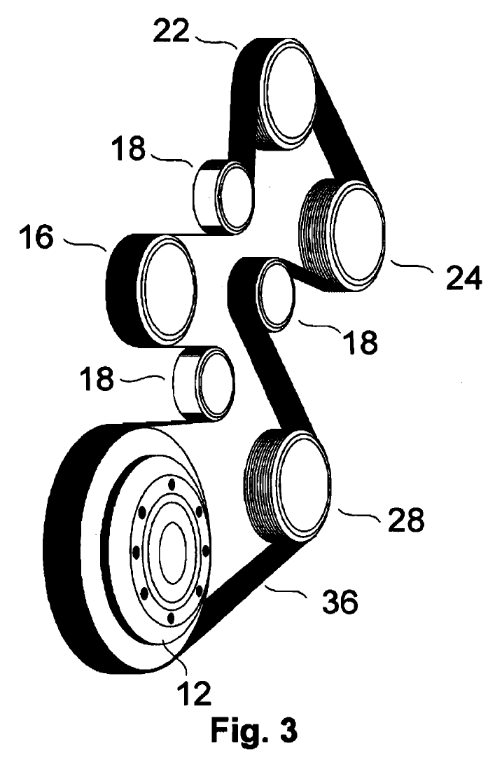

FIG. 3 shows another embodiment wherein the hydraulic motor is eliminated. This embodiment comprises a free-wheeling one-way pulley, sprocket or gear that is physically fastened to the crankshaft of a prime mover and also physically connected to the prime mover's ancillary rotating equipment by means of a flexible conveyance, such as a belt or chain, for the purpose of alleviating backlash and mechanical stress on said prime mover and said ancillary rotating equipment, allowing the ancillary rotating equipment to continue to rotate by inertia after an abrupt deceleration or stoppage of said prime mover. This invention can also serve the purpose of providing a means for using an auxiliary engine that is physically connected by a second free-wheeling one-way pulley, sprocket or gear to the first free-wheeling one-way pulley, sprocket or gear on said prime mover for the purpose of operating ancillary rotating equipment, as desired, when said prime mover has been shut down. Said free-wheeling one-way devices can be locked by a variety of methods that include but are not limited to: 1) a mechanically locking cam similar to a “Morse” one-way cam or roller ramp clutch, also referred to as a “freewheel,” “sprag clutch” or “one-way clutch,”; 2) a pneumatic (air) locking clutch similar to the pneumatically actuated clutch on an automotive cooling fan; or 3) an electric locking clutch similar to the electromagnetically actuated clutch on an automotive refrigerant compressor, or other means of actuation known by those skilled in the art. The implementation of this invention requires only the modification or replacement of a crankshaft pulley, sprocket or gear on said prime mover.

While the prime mover is in operation, said free-wheeling one-way pulley, sprocket or gear attached to other pulleys by flexible conveyance create almost no drag on said prime mover and, consequently, create no additional horsepower drain or fuel consumption.

The following is a list of components of the power system, as shown in the figures:
Companion Engine 10
Freewheeling Cam-Locking Crankshaft Pulley 12
Freewheeling Cam-Locking Pulley 14
Fan Pulley 16
Idler Pulley 18
Primary Engine 20
Alternator Pulley 22
A/C Compressor Pulley 24
Hydraulic Lines 26
Water Pump Pulley 28
Hydraulic Motor 30
Bracket for Hydraulic Motor 32
Flexible Belt 34
Serpentine Belt 36
Hydraulic Pump 38
Electronic Controls 40
Water Pump 42
Companion Engine Crankshaft 44
Hydraulic Motor Driveshaft 46
Electrical Connections 48
Battery 50
DC Power Cable 52
Primary Engine Crankshaft 54
Primary Engine Crankshaft Pulley 56
Ground 58
Coolant/Anti-Freeze Lines 60
Fuel Lines 62
Fuel Tank 64

While the invention has been shown in only some of its forms, it should be apparent to those skilled in the art that it is not so limited, but is susceptible to various changes and modifications without departing from the scope of the invention.

I claim:

1. A power system for a vehicle comprising:
a primary combustion engine for powering a drive system of the vehicle for propelling the vehicle and non-drive systems associated with the vehicle in a first mode of operation; and
an auxiliary combustion engine that is coupled to the primary engine for powering the non-drive systems in a second mode of operation when the primary combustion engine is powered off, the auxiliary engine being powered by the same fuel as the primary engine, the auxiliary combustion engine being coupled to the primary engine through at least one clutch that disengages and engages the auxiliary engine from the primary engine when the primary engine is powered on and off.

2. The power system of claim 1, wherein:
the primary combustion engine and auxiliary combustion engine are fueled from the same fuel tank.

3. The power system of claim 1, wherein:
the non-drive systems include at least one of an alternator, an air conditioner compressor, a hydraulic motor, a water pump, a fuel pump and a fan.

4. The power system of claim 1, wherein:
the auxiliary engine has a cooling system that provides a heated fluid during operation of the auxiliary engine that is circulated through a cooling system of the primary engine.

5. The power system of claim 1, wherein:
the auxiliary engine and primary engine are coupled together through a flexible belt.

6. The power system of claim 1, wherein:
the auxiliary engine a manifold water jacket heat exchanger.

7. The power system of claim 1, wherein:
the at least one clutch is a freewheeling cam-locking clutch.

8. The power system of claim 1, wherein:
the auxiliary engine consumes 20% or less the amount of fuel as the primary engine when operating the non-drive systems.

9. The power system of claim 1, wherein:
the primary and auxiliary engines are powered by at least one of diesel, gasoline, biodiesel, liquid biofuels, ethanol, methanol, methane or light hydrocarbon gases.

10. A method of powering a vehicle comprising:
powering a drive system of the vehicle for propelling the vehicle and non-drive systems associated with the vehicle through a primary combustion engine in a first mode of operation; and
powering the non-drive systems when the primary combustion engine is powered off in a second mode of operation with an auxiliary combustion engine that is coupled to the primary engine, the auxiliary engine being powered by the same fuel as the primary engine, the auxiliary combustion engine being coupled to the primary engine through at least one clutch that disengages and engages the auxiliary engine from the primary engine when the primary engine is powered on and off.

11. The method of claim 10, wherein:
the primary combustion engine and auxiliary combustion engine are fueled from the same fuel tank.

12. The method of claim 10, wherein:
the non-drive systems include at least one of an alternator, an air conditioner compressor, a hydraulic motor, a water pump, a fuel pump and a fan.

13. The method of claim 10, wherein:
the auxiliary engine has a cooling system that provides a heated fluid during operation of the auxiliary engine that is circulated through a cooling system of the primary engine.

14. The method of claim 10, wherein:
the auxiliary engine and primary engine are coupled together through a flexible belt.

15. The method of claim 10, wherein:
the auxiliary engine a manifold water jacket heat exchanger.

16. The method of claim 10, wherein:
the at least one clutch is a freewheeling cam-locking clutch.

17. The method of claim 10, wherein:
the auxiliary engine consumes 20% or less the amount of fuel as the primary engine when operating the non-drive systems.

18. The method of claim 10, wherein:
the primary and auxiliary engines are powered by at least one of diesel, gasoline, biodiesel, liquid biofuels, ethanol, methanol, methane or light hydrocarbon gases.
